(19) United States
(12) Patent Application Publication
(10) Pub. No.: US 2020/0386590 A1
(43) Pub. Date: Dec. 10, 2020

(54) Ultrasonic Flowmeter Element

(71) Applicant: Badger Meter, Inc., Milwaukee, WI (US)

(72) Inventors: Matthew L. Stuyvenberg, Menomonee Falls, WI (US); Eric Metzger, Franklin, WI (US); Carl Carlander, Luleâ (SE)

(21) Appl. No.: 16/434,845

(22) Filed: Jun. 7, 2019

(51) Int. Cl. G01F 1/66

(52) U.S. Cl. CPC G01F 1/662; G01N 2291/02836; G01F 1/667

(57) ABSTRACT

A signal path definition element defining an ultrasonic signal path for ultrasonic signals transmitted and received by an ultrasonic flow meter is provided. The element includes two end reflection plates, a top reflection plate, and a plurality of support plates joining and positioning the two end reflection plates and the top reflection plate. Further, the end reflection plates, the top reflection plate, and the plurality of support plates are formed from a single stamped metal plate and folded such that the end reflection plates reflect ultrasonic signals between an ultrasonic signal transducer and the top reflection plate and the top reflection plate reflects ultrasonic signals between the end reflection plates.

### FIELD OF THE INVENTION

This application relates to the field of fluid measurement devices. More specifically, this application relates to an insertion vortex element for generating a vortex signal at a greater amplitude, higher frequencies and for lower velocities.

### BACKGROUND

Ultrasonic flow meters utilize transducers to send and receive ultrasonic signals through a flow stream to measure the velocity of flow through a conduit. Where the transducers include an upstream transducer and a downstream transducer, the flowmeter is configured to measure a “time-of-flight” of an ultrasonic signal transmitted between the two, spaced apart, transducers. The ultrasonic signal travels from a first transducer, along an ultrasonic signal path through the fluid and/or gas flowing through the conduit, to be received by a second transducer. The elapsed time between when the signal is sent from the first transducer and received by the second transducer is the time-of-flight, which can be used to calculate the velocity of the flow through the conduit. The velocity of the flow through the conduit can, in turn, be used to calculate a flow rate and/or flow volume.

However, such flow measurement may be difficult where the flow is asymmetric or inconsistent across the ultrasonic signal path, etc. Such inconsistencies may be caused by, for example, rotational flow or asymmetric flow caused by upstream conduit configurations, vibrations along the conduit, inconsistencies in the fluid or gas flowing through the conduit, etc. These inconsistencies will, in turn, result in measurement inaccuracies.

Inaccuracies introduced by asymmetric and/or inconsistent flow may be reduced by increasing the length of the path of the ultrasound signal as it is transmitted between transducers. A longer ultrasonic signal path typically reduces the effect of individual asymmetric and/or inconsistent flow anomalies. Lengthening the ultrasonic signal path is typically accomplished through use of mirrors/reflectors within the conduit and such that the ultrasonic signal will be “bounced” one or more times before being received by the receiving transducer. Further, the diameter and/or cross-section of the conduit can be reduced within a measurement area through with the ultrasonic signal travels. Reducing the diameter within the measurement area has the effect of reducing inconsistencies in the fluid or gas flow.

However, this approach may itself introduce a source of inconsistencies and/or difficulties in the flow measurement. For example, having a longer length of an ultrasonic signal path is difficult where flow is being measured with a smaller diameter conduit and/or within a reduced measurement area. Increasing the length of an ultrasonic signal path in a smaller conduit may require utilization of multiple mirrors and/or reflection points within the conduit in order to have an ultrasonic signal path of sufficient length to reduce the inaccuracies caused by inconsistent and/or asymmetric flow.

However, including multiple mirrors and/or reflectors increases the number of parts in the ultrasonic flow meter, which both increases cost and introduces an increased risk of potential manufacturing errors. The errors may be caused by issues with the parts, issues with mounting the parts, etc. Further, over the life of the ultrasonic meter, using multiple reflectors and/or mirrors increases the number of parts that may fail, increases the number of part mounting points that may fail, etc.

What is needed is a system for defining a consistent ultrasonic signal path in an ultrasonic flow meter. What is further needed is such a system that can be easily and consistent manufactured and implemented.

### SUMMARY OF THE INVENTION

The present invention provides an ultrasonic flow meter that includes a hydraulic circuit insert including an ultrasonic signal path defining element. The hydraulic circuit insert is configured for insert within a conduit through which fluid or gas flows and is measured the ultrasonic flow using transducers transmitting and receiving ultrasonic signals through the fluid or gas flow. The ultrasonic signal path defining element is configured to define an ultrasonic signal path that includes at least three reflections between transmission and reception of each ultrasonic signal.

In one more detailed aspect, a signal path definition element defining an ultrasonic signal path for ultrasonic signals transmitted and received by an ultrasonic flow meter is provided. The element includes two end reflection plates, a top reflection plate, and a plurality of support plates joining and positioning the two end reflection plates and the top reflection plate. Further, the end reflection plates, the top reflection plate, and the plurality of support plates are formed from a single stamped metal plate and folded such that the end reflection plates reflect ultrasonic signals between an ultrasonic signal transducer and the top reflection plate and the top reflection plate reflects ultrasonic signals between the end reflection plates.

In another embodiment of the invention, an ultrasonic signal transmitted from an ultrasonic signal transducer will be reflected three times by the reflecting plates of the reflection.

In another embodiment of the invention, the plurality of support plates includes two end support plates, a sidewall support plate and a bottom support plate. Further, the top reflection plate, the sidewall support plate and the bottom support plate may be configured to define a flow measurement area. Yet further, the end support plates may join the end reflection plates to the bottom support plate. In this embodiment, the folds in the joints between the end reflection plates and the bottom support plate position the end reflection plates to provide the reflections between an ultrasonic signal transducer and the top reflection plate.

In another more detailed aspect, a hydraulic circuit insert for use with an ultrasonic flow meter including a signal path definition element defining an ultrasonic signal path for ultrasonic signals transmitted and received by the ultrasonic flow meter is provided. The insert includes first and second insert halves configured for insertion in a conduit and position to receive ultrasonic signals transmitted by the ultrasonic flow meter and a signal path definition element affixed between and inside of the first and second insert halves. The signal path definition element defining an ultrasonic signal path for ultrasonic signals transmitted and received by an ultrasonic flow meter is provided. The element includes two end reflection plates, a top reflection plate, and a plurality of support plates joining and positioning the two end reflection plates and the top reflection plate. Further, the end reflection plates, the top reflection plate, and the plurality of support plates are formed from a single stamped metal plate and folded such that the end reflection plates reflect ultrasonic signals between an ultrasonic signal transducer and the top reflection plate and the top reflection plate reflects ultrasonic signals between the end reflection plates.

In another embodiment of the invention, the insert includes a plurality of flow conditioners configured to condition fluid and/or gas flowing through the hydraulic circuit insert.

In another embodiment of the invention, the insert includes a plurality of reducers configured to restrict the cross section of the insert along a portion of an axis of the hydraulic circuit insert. Further, the plurality of reducers may cooperatively forms a flow measurement area. The flow measurement area may be essentially rectangular and bordered on three sides by the top reflection plate, the sidewall support plate and the bottom support plate.

Other aspects of the invention, besides those discussed above, will be apparent to those of ordinary skill in the art from the description of exemplary embodiments which follows. In the description, reference is made to the accompanying drawings, which form a part hereof, and which illustrate examples of the invention.

### BRIEF DESCRIPTION OF THE DRAWINGS

FIG. 1A is a perspective view of an ultrasonic flow meter assembly, according to an exemplary embodiment;

FIG. 1B is an end view of the ultrasonic flow meter assembly of FIG. 1A, looking along the axis of a conduit, according to an exemplary embodiment;

FIG. 2A is a perspective view of a hydraulic circuit insert, according to an exemplary embodiment;

FIG. 2B is an end view of the hydraulic circuit insert of FIG. 2A, looking along the axis of a conduit, according to an exemplary embodiment;

FIG. 3A is a top cross-section view of the hydraulic circuit insert of FIG. 2A, according to an exemplary embodiment;

FIG. 3B is a side interior view of a first half of the hydraulic circuit insert of FIG. 2A, according to an exemplary embodiment;

FIG. 3C is a side interior view of a second half of the hydraulic circuit insert of FIG. 2A, according to an exemplary embodiment;

FIGS. 4A-C are a perspective view, a top view and a side view, respectively, of a signal path definition element, according to an exemplary embodiment; and

FIG. 5 is a representation of an ultrasonic signal path between transducers of the ultrasonic flow meter of FIG. 1 as defined by the signal path definition element of FIGS. 4A-C, according to an exemplary embodiment.

### DETAILED DESCRIPTION OF THE INVENTION

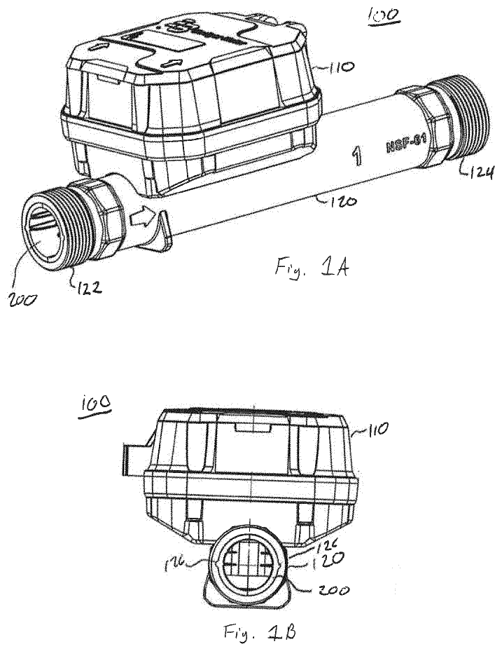

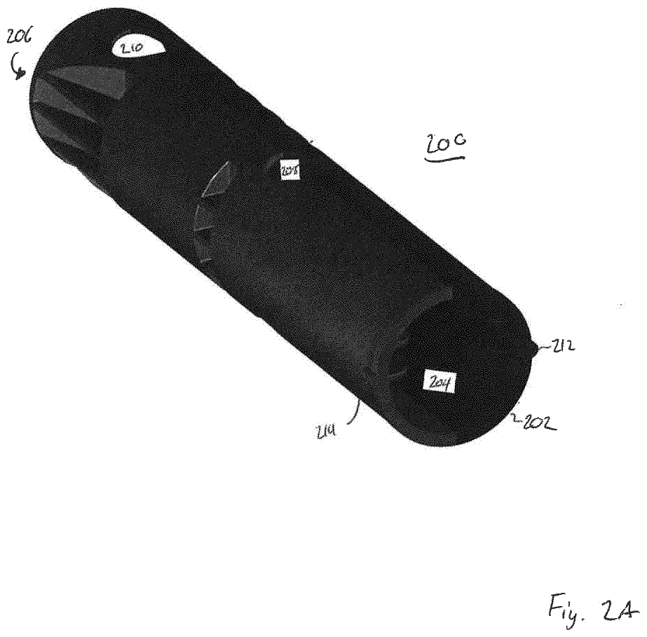

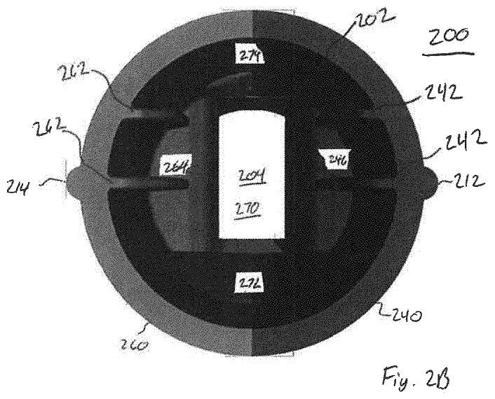

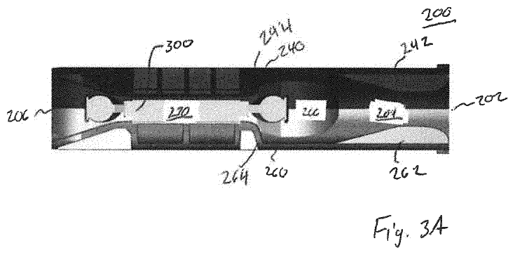

Referring first to FIGS. 1A and 1B, a perspective view and an end view, respectively, of an ultrasonic flow meter assembly 100 are shown, according to an exemplary embodiment. The ultrasonic flow meter assembly 100 includes an ultrasonic flow meter 110, a conduit 120, and a hydraulic circuit insert 200. Hydraulic circuit insert 200 is shown and further described below with reference to FIGS. 2A-E. Although a specific configuration of an ultrasonic flow meter assembly 100 is shown and described herein, one of ordinary skill in the art should understand that the invention described herein may be applied to any ultrasonic flow meter assembly configurable to use the signal path definition element described herein.

Ultrasonic flow meter 110 may be a solid state, ultrasonic measurement system configured to measure and report flow of a fluid or gas through the conduit 120. Ultrasonic flow meter 110 may be configured to be totally encapsulated, weatherproof and UV-resistant within a flow meter housing. Ultrasonic flow meter 110 may be coupled to conduit 120 using clamps, adhesives, etc. In one embodiment, the flow meter housing of ultrasonic flow meter 110 is integrally formed with conduit 120 during manufacturing.

Although not shown, additional elements and electronic components of the ultrasonic flow meter 110 may be positioned within the flow meter housing and/or conduit 120, such as the transducers generating and receiving the ultrasonic signals. Flow meter 110 may further include additional sensors such as a temperature sensor, a pressure sensor, a backflow sensor, etc. Total flow volume is calculated from the measured flow velocity using additional information such as temperature, pipe diameter of conduit 120, etc.

As fluid and/or gas flows into the conduit 120, through an upstream spud end 122, ultrasonic signals are sent consecutively in forward and reverse directions of flow prior to the fluid or gas exiting the conduit 120 through a downstream spud end 124. Velocity of the fluid or gas is then determined by measuring the time difference between the measurement in the forward and reverse directions.

The measured and calculated values, including the flow value, may be converted to electrical pulses which are counted as units of consumption of a fluid or gas. These signals may then be transmitted by an internal radio transceiver or through a cable to an external radio transceiver or other system. The radio transceiver typically includes a radio transmitter portion and a radio receiver portion. The radio transmitter portion converts the measurement system signals to a radio frequency signaling protocol for transmission back to a network data collector through a wireless network.

Conduit 120 may be any type of conduit for transporting a fluid or gas between the upstream spud end 122 and the downstream spud end 124. Conduit 120 may be configured to have a total length of approximately 10.75 inches. Conduit 120 may be further configured to fit within the lay length of a standard water meter, approximately 9.75 inches between the ends of the threaded portions shown in FIG. 1A, such that additional retrofits to install the meter and valve aren't required. Conduit 120 may be provided in any of a variety of sizes, dependent on the volume of fluid or gas being transported. In one exemplary embodiment, the present invention is used in conduit 120 having diameter of 1 inch or 1.5 inches. Conduit 120 includes upstream spud end 122 and downstream spud end 124. The spud ends 122, 124 of the conduit 120, although shown as threaded pipe ends, can be replaced by coupling flanges in larger sized meters.

According to an exemplary embodiment, conduit 120 encompasses and holds a hydraulic circuit insert 200 within the length of the conduit 120. The hydraulic circuit insert 200 may be configured to be less than the length of the conduit 120 but positioned along the length of conduit 120 relative to the ultrasonic flow meter 110. The hydraulic circuit insert 200 is positioned relative to the ultrasonic flow meter 110 to facilitate measurement of the flow velocity through conduit 120.

Referring next to FIG. 2, a perspective view of a hydraulic circuit insert 200, removed from the conduit 120, is shown, according to an exemplary embodiment. The hydraulic circuit insert 200 is configured for insertion and retention in a position relative to the position of ultrasonic flow meter 110 along the length of the conduit 120. The hydraulic circuit insert 200 holds a signal path definition element 300 relative to the transducers of ultrasonic flow meter 110 and facilitates minimally turbulent and/or non-turbulent fluid or gas flow at various points through the conduit 120 and hydraulic circuit insert 200 to facilitate accurate flow measurement by meter 110.

The hydraulic circuit insert 200 includes an upstream flow opening 202, a flow passageway 204, and a downstream flow opening 206. In an exemplary embodiment, insert 200 is configured such that the external diameter of hydraulic circuit insert 200 is configured to match the internal diameter of the conduit 120. According, in this configuration, fluid entering conduit 120 through upstream spud end 122 necessarily enters hydraulic circuit 200 through upstream flow opening 202. Fluid entering upstream flow opening 202 will be transported through flow passageway 204, exiting the hydraulic circuit insert 200 through downstream flow opening 206.

The hydraulic circuit insert 200 includes ultrasonic signal openings 208 and 210. In operation, an ultrasonic signal transmitted by a transducer of meter 100 will enter hydraulic insert 200 through one of openings 208 and 210, dependent on whether the signal is being transmitted with or against the direction of the flow through insert 200. Insert 200 is configured for retention in a position relative to the transducers of the ultrasonic flow meter 110, such that ultrasonic signals transmitted by the transducers enter and exit insert 200 without interference. Ultrasonic signals openings 208 and 210 may be sized and shaped based on the transducers used in ultrasonic flow meter 110 to avoid such interference.

In order to maintain the position of hydraulic circuit insert 200 within conduit 120, relative to meter 110, hydraulic circuit insert 200 further includes positioning tabs 212 and 214, configured to extend external from the diameter of insert 200 at upstream flow opening 202. Positioning tabs 212 and 214 are also configured to extend along the length of insert 200, a small portion of the distance between upstream flow opening 202 and downstream flow opening 206. Referring now also to FIG. 1B, positioning tabs 212 and 214 are configured to interface with receiving openings 126 formed to extend external to an internal diameter of conduit 120, into the wall of conduit 120. Positioning tabs 212 and 214 are configured to interface with receiving openings 126 to receive and hold hydraulic circuit insert 200 within conduit 120 in a position relative to meter 110. Accordingly, hydraulic insert 200 may be inserted axially into conduit 120 through upstream spud end 122 during assembly.

Hydraulic circuit insert 200 may be made of a polymer, plastic, stainless steel, etc. Hydraulic circuit insert 200 may be formed, cast, etc. as described herein. Hydraulic circuit insert 200 may be configured as show in FIG. 1 to include supporting members reinforcing internal structures described hereinbelow.

Referring now to FIG. 2B, an axial view of hydraulic circuit insert 200, viewing hydraulic circuit insert 200 along its axis from upstream flow opening 202 towards downstream flow opening 206, is shown, according to an exemplary embodiment. Hydraulic circuit insert 200 may be configured to be a two-piece assembly including a first half 240 and a second half 260. First half 240 and second half 260, in an assembled position, define flow passageway 204.

First half 240 and second half 260 are joined and relatively positioned using one or more anchors, clips, pins, etc. First half 240 and second half 260 may further be positioned and held into position based on a compression fitting within conduit 120 in cooperation with the positioning tabs 212 and 214.

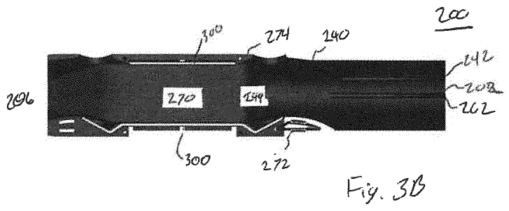

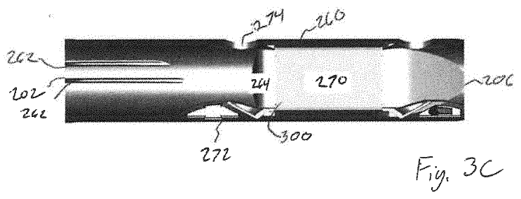

Referring now also to FIGS. 3A-C, the features of insert 200, first half 240 and second half 260 are shown in greater detail. FIG. 3A is a topside cross-section view of hydraulic circuit insert 200, viewing hydraulic circuit insert 200 from the position of the ultrasonic flow meter 110 across the diameter of the insert 200, is shown, according to an exemplary embodiment. FIG. 3B is a side view of the front half 240, viewing the portion of front half 240 that will define flow passageway 204 when front half 240 is attached to second half 260, according to an exemplary embodiment. FIG. 3C is a side view of the second half 260, viewing the portion of second half 260 that will define flow passageway 204 when second half 260 is attached to front half 240, according to an exemplary embodiment.

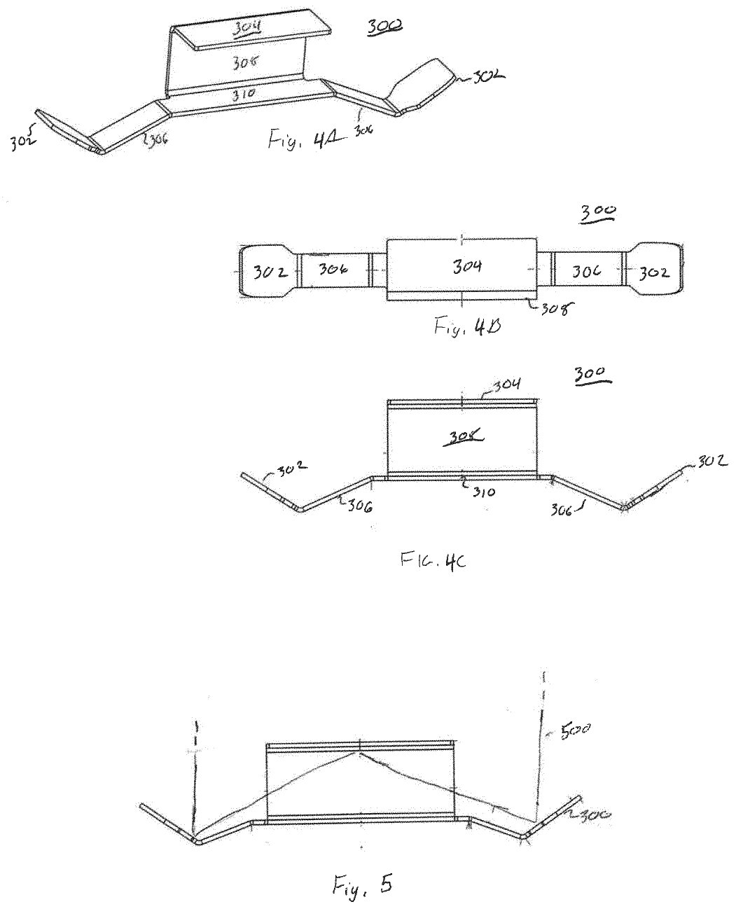

The hydraulic circuit insert 200 is configured to receive and hold signal path definition element 300, further described below with reference to FIGS. 4A-C, in position relative to the transducers of ultrasonic flow meter 110 and the ultrasonic signal openings 208 and 210 of insert 200. Signal path definition element 300 is configured to interact with ultrasonic signals transmitted between transducers of the ultrasonic flow meter 110 to define a signal path to and from the transducers. Signal path definition element 300 is shown in cross-section in FIGS. 3A-C, the cross section being dependent on the view being shown.

Insert 200 includes a plurality of flow conditioning vanes 242 and 262 configured to extend from an internal diameter of insert 200 into flow passageway 204. In the embodiment shown, first half 240 includes two flow conditioning vanes 242 extending from the interior wall of the first half 240 into the passageway 204. In alternative embodiments, additional and/or fewer flow conditioning vanes may be provided having various configurations such as, for example, thicknesses and length from the interior wall into the passageway 204. As can be seen in FIG. 2B, vanes 242 may include a slight taper, narrowing in thickness as the vane extends from the interior wall of first-half 240 into the passageway 204.

Vanes 262 of second half 260 may be configured similarly to vanes 242 as described above. In an alternative embodiment, vanes 262 may have a different shape, length, axis length, thickness, etc. dependent on the desired flow conditioning affect.

Vanes 242 and 262 are configured to reduce and/or eliminate irregular or asymmetrical flow entering into insert 200 through upstream flow opening 202. Vanes 242 and 262 may further be configured to interact cooperatively with reducers in each of the halves 240 and 260, described hereinbelow.

As fluid and/or gas passes through the flow passageway 204 and further passes through flow conditioning vanes 242 and 262, insert 200 is configured to include a plurality of reducers constricting the cross-section area of the flow passageway 204. Constricting the cross-section area has the effect of further conditioning the flow, increasing the flow through the constriction in low flow situations, introducing Venturi effects that are measurable by ultrasonic flow meter 110, etc.

Insert 200 is configured to include a first sidewall reducer 244 extending from the interior wall of first half 240 into passageway 204, a second sidewall reducer 264 extending from the interior wall of second half 260 into passageway 204, a bottom wall reducer 272 extending from a bottom wall cooperatively formed by first half 240 and second half 260 into passageway 204, and a top wall reducer 274 extending from a top wall cooperatively formed by first half 240 and second half 260 into passageway 204. Although specific implementations of reducers 244, 264, 272 and 274 are shown in FIGS. 3A-3C, it should be understood that the specific shape, height, grade, etc. of the reducers may be varied for different reduction effects and/or conduit diameters.

Reducers 244, 264, 272 and 274 extend the length of the passageway 204 correlating to the location of the transducers of the ultrasonic flow meter 110 to define a flow measurement area 270 within passageway 204. As shown in FIG. 2B, measurement area 270 may be a rectangular passageway within flow passageway 204. Ultrasonic flow meter 110 transmits ultrasonic signals along a defined signal path through the flow measurement area 270 in calculating the flow through conduit 120.

According to an exemplary embodiment, a backside of reducers 244, 264, 272 and 274, on the side of each reducer closest to downstream flow opening 206, is configured to interact cooperatively with signal path definition element 300 to provide a smooth transition from the reducers into the flow measurement area 270. Accordingly, the backside of one or more of the reducers will have a lip that correlates to a thickness of the signal path definition element 300, described in more detail below. Additionally, the backside of bottom reducer 272 may include anchoring extensions, extending over signal path definition element 300 to affix element 300 to the bottom wall cooperatively formed by first half 240 and second half 260.

Referring now to FIGS. 4A-4C, a perspective view, a top view and a side view, respectively, of a signal path definition element 300 are shown, according to an exemplary embodiment. Signal path definition element 300 may be a single stamped metal element, folded as described hereinbelow. Element 300 may be cut from 316 stainless steel, formed using metal stamping as is known in the art and then passivated. Passivating includes a process for making the stainless steel unreactive by altering the surface layer or coating the surface with a thin inert layer. Element 300 is further configured to form a signal path for ultrasonic signals emitted from ultrasonic flow meter 110. Signal path definition element 300, in its folded configuration, may be sized dependent on usage and folded to correlate with the type and size of conduit 120, the type of ultrasonic flow meter 110, the flow measurement area 270, etc.

Signal path definition element 300 includes two end reflection plates 302 configured to reflect signals directly to or from transducers of the ultrasonic flow meter 110. Each end reflection plate 302 is associated with and will reflect signals to or from a different transducer of the ultrasonic flow meter 110. Signal path definition element 300 further includes a top reflection plate 304 configured to reflect signals reflected by one of the end reflection plates 302 to the other end reflection plate 302. Reflection plates 302 and 304 will be sized, shaped and configured to maximize ultrasonic reflection and transmission between the transducers of ultrasonic flow meter 110.

Signal path definition element 300 further includes reflection plate support plates configured to align the reflection plates 302, 304 within the measurement area 270. The support plates are configured to align the reflection plates 302 to receive signals from transducers of the ultrasonic flow meter 110 and reflect those signals to the top reflection plate 304 and, in the reverse direction, to receive signals reflected by the top reflection plate 304 and in turn reflect those signals to transducers of the ultrasonic flow meter 110. Accordingly, signal path definition element 300 includes in support plates 306, a sidewall support plate 308 and a bottom support plate 310.

End support plates 306 are configured to join end reflection plates 302 to bottom support plate 310. End support plates 306 are affixed to both of end reflection plates 302 and bottom support plate 310 at specific angles to position the end reflection plates such that signals reflected off of end reflection plates 302 will be reflected between transducers and top reflection plate 304. The specific angles and sizes of these components will vary based on the size of the element 300 as it is correlated to the diameter of the conduit 120 in which it is to be used.

Bottom support plate 310 is configured to join end support plates 306 to each other and to sidewall support plate 308. Sidewall support plate 308 is configured to join top reflection plate 304 to bottom support plate 310. Bottom support plate 310, sidewall support plate 308, and top reflector 304 are joined at right angles and form three sides of the flow measurement area 270, the fourth side being provided by a top of one of the sidewall reducers 244 or 264, dependent on the particular configuration been used. Again, the specific angles and sizes of these components will vary based on the size of the element 300 as it is correlated to the diameter of the conduit 120 in which it is to be used.

Referring now to FIG. 5, signal path definition element 300 is shown reflecting ultrasonic signals to define an ultrasonic signal path 500 between transducers (not shown) of the ultrasonic flow meter 110. End reflection plates 302 are configured to reflect ultrasonic signals between the transducers of the ultrasonic flow meter 110 and top reflection plate 304. In turn, topper flexion plate 304 is configured to reflect ultrasonic signals between the end reflection plates 302.

In operation, signal path definition element 300 will provide three reflections within a flow measurement area 270 of the insert 200. The three reflections will define an “inverted M” ultrasonic signal path 500 as shown in FIG. 5. Advantageously, signal path 500, even when implemented within a relatively small conduit 120 and insert 200, will define a relatively long ultrasonic signal path to increase the accuracy of the flow measurement provided by ultrasonic flow meter 110.

This has been a description of exemplary embodiments, but it will be apparent to those of ordinary skill in the art that variations may be made in the details of these specific embodiments without departing from the scope and spirit of the present invention, and that such variations are intended to be encompassed by the following claims.

We claim:

1. A signal path definition element defining an ultrasonic signal path for ultrasonic signals transmitted and received by an ultrasonic flow meter, comprising:
two end reflection plates;
a top reflection plate; and
a plurality of support plates joining and positioning the two end reflection plates and the top reflection plate,
wherein the end reflection plates, the top reflection plate, and the plurality of support plates are formed from a single stamped metal plate and folded such that
the end reflection plates reflect ultrasonic signals between an ultrasonic signal transducer and the top reflection plate and
the top reflection plate reflects ultrasonic signals between the end reflection plates.

2. The signal path definition element of claim 1, wherein an ultrasonic signal transmitted from an ultrasonic signal transducer will be reflected three times by the reflecting plates of the reflection.

3. The signal path definition element of claim 1, wherein the plurality of support plates includes two end support plates, a sidewall support plate and a bottom support plate.

4. The signal path definition element of claim 3, wherein the top reflection plate, the sidewall support plate and the bottom support plate define a flow measurement area,

5. The signal path definition element of claim 3, wherein the end support plates join the end reflection plates to the bottom support plate.

6. The signal path definition element of claim 5, wherein the folds in the joints between the end reflection plates and the bottom support plate position the end reflection plates to provide the reflections between an ultrasonic signal transducer and the top reflection plate.

7. A hydraulic circuit insert for use with an ultrasonic flow meter including a signal path definition element defining an ultrasonic signal path for ultrasonic signals transmitted and received by the ultrasonic flow meter, comprising:
first and second insert half configured for insertion in a conduit and position to receive ultrasonic signals transmitted by the ultrasonic flow meter; and
a signal path definition element affixed between and inside of the first and second insert halves, including
two end reflection plates;
a top reflection plate; and
a plurality of support plates joining and positioning the two end reflection plates and the top reflection plate,
wherein the end reflection plates, the top reflection plate, and the plurality of support plates are formed from a single stamped metal plate and folded such that
the end reflection plates reflect ultrasonic signals between an ultrasonic signal transducer and the top reflection plate and
the top reflection plate reflects ultrasonic signals between the end reflection plates.

8. The hydraulic circuit insert of claim 7, wherein an ultrasonic signal transmitted from an ultrasonic signal transducer will be reflected three times by the reflecting plates of the reflection.

9. The hydraulic circuit insert of claim 7, wherein the plurality of support plates includes two end support plates, a sidewall support plate and a bottom support plate.

10. The hydraulic circuit insert of claim 9, wherein the top reflection plate, the sidewall support plate and the bottom support plate define a flow measurement area.

11. The hydraulic circuit insert of claim 9, wherein the end support plates join the end reflection plates to the bottom support plate.

12. The hydraulic circuit insert of claim 11, wherein the folds in the joints between the end reflection plates and the bottom support plate position the end reflection plates to provide the reflections between an ultrasonic signal transducer and the top reflection plate.

13. The hydraulic circuit insert of claim 7, further including a plurality of flow conditioners configured to condition fluid and/or gas flowing through the hydraulic circuit insert.

14. The hydraulic circuit insert of claim 7, further including a plurality of reducers configured to restrict the cross section of the insert along a portion of an axis of the hydraulic circuit insert.

15. The hydraulic circuit insert of claim 14, wherein the plurality of reducers cooperatively forms a flow measurement area.

16. The hydraulic circuit insert of claim 15, wherein the flow measurement area is essentially rectangular and bordered on three sides by the top reflection plate, the sidewall support plate and the bottom support plate.
